(19) United States
(12) Patent Application Publication
(10) Pub. No.: US 2010/0055768 A1
(43) Pub. Date: Mar. 4, 2010

(54) CLEANING AND/OR TREATMENT COMPOSITIONS

(76) Inventor: Neil Joseph Lant, Newcastle Upon Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/548,472

(22) Filed: Aug. 27, 2009

Related U.S. Application Data
(60) Provisional application No. 61/190,305, filed on Aug. 27, 2008.

(51) Int. Cl. D06M 16/00; C11D 7/42; C12S 9/00; C12S 11/00

(52) U.S. Cl. 435/263; 510/392; 510/320

(57) ABSTRACT

This invention relates to compositions comprising certain peroxidases and processes for making and using such compositions including the use of such compositions to clean and/or treat a situs, for example fabrics and surfaces. Such compositions provide enhanced cleaning and/or treatment benefits, for example soil bleaching and whiteness maintenance.

### CROSS-REFERENCES TO RELATED APPLICATIONS

This application claims priority under 35 U.S.C. §119(e) to U.S. Provisional Application Ser. No. 61/190,305 filed Aug. 27, 2008.

### FIELD OF INVENTION

Compositions comprising enzymes and processes for making and using such compositions.

### BACKGROUND OF THE INVENTION

The appearance of enzymes suitable for cleaning and/or treatment applications gave the formulator a new approach to clean and/or treat hard surfaces and fabrics. Unfortunately, even when enzymes are employed, performance issues remain. For example, bleaching enzymes, including currently commercially available peroxidases, do not provide the desired level of bleaching performance. While not being bound by theory, Applicants believe that this is due to such enzymes' narrow range of substrate specificity, which in turn, Applicants' believe, is due to the restricted nature of such enzymes' active sites. Thus, the use of this technology continues to be limited.

Surprisingly, when cleaning and/or treatment compositions, containing peroxidases having more accessible active sites, are formulated in accordance with the teachings of the present invention, improved cleaning, including but not limited to soil bleaching may be obtained.

### SUMMARY OF THE INVENTION

This invention relates to compositions comprising certain peroxidase enzymes and processes for making and using such products.

### DETAILED DESCRIPTION OF THE INVENTION

### Definitions

Isolated polypeptide: The term “isolated polypeptide” as used herein refers to a polypeptide which is at least 20% pure, preferably at least 40% pure, more preferably at least 60% pure, even more preferably at least 80% pure, most preferably at least 90% pure, and even most preferably at least 95% pure, as determined by SDS-PAGE.

Identity: The relativity between two amino acid sequences or between two nucleotide sequences is described by the parameter “identity”.

For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of the present invention (“invention sequence”; amino acids 1 to 343 of SEQ ID NO:2) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity.

An exact match occurs when the “invention sequence” and the “foreign sequence” have identical amino acid residues in the same positions of the overlap (in the alignment example below this is represented by “|”). The length of a sequence is the number of amino acid residues in the sequence (e.g. the length of SEQ ID NO: 1 is 343).

In the alignment example below, the overlap is the amino acid sequence “HTWGER-NL” of Sequence 1; or the amino acid sequence “HGWGEDANL” of Sequence 2. In the example a gap is indicated by a “−”.

Hypothetical alignment example:

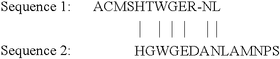

As used herein, the term “cleaning and/or treatment composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents; liquid cleaning and disinfecting agents, including antibacterial hand-wash types, laundry bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, the term “dry laundry” encompasses powders.

As used herein, the term “liquid laundry” encompasses liquids.

As used herein, the phrase “is independently selected from the group consisting of . . . ” means that moieties or elements that are selected from the referenced Markush group can be the same, can be different or any mixture of elements.

As used herein, articles, for example, “a” and “an” when used in a claim, are understood to mean one or more of what is claimed or described.

As used herein, the terms “include”, “includes” and “including” are meant to be non-limiting.

The test methods disclosed in the Test Methods Section of the present application should be used to determine the respective values of the parameters of Applicants' inventions.

Unless otherwise noted, all component or composition levels are in reference to the active level of that component or composition, and are exclusive of impurities, for example, residual solvents or by-products, which may be present in commercially available sources.

Unless otherwise noted, the enzymes of the present invention are expressed in terms of active protein level and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Compositions

In one aspect, a first composition comprising, based on total composition weight, from about 0.00005% to about 20.0%, from about 0.0001% to about 1.0%, from about 0.005% to about 0.3%, or even from about 0.005% to about 0.1%, of a peroxidase selected from the group consisting of:
a.) a peroxidase being at least 70%, at least 80%, at least 90% or even at least 95% identity to SEQ ID NO: 1 when said SEQ ID NO: 1 has one of the following groups of mutations:
   (i) R51 is substituted by alanine, glycine, leucine, isoleucine, valine, asparagine, serine or threonine; F54 is substituted by glycine, alanine, valine, leucine, isoleucine, methionine, or proline; H55 is substituted by glycine, alanine, valine, leucine, isoleucine, methionine, proline, serine, threonine, asparagine, tyrosine, cysteine, aspartic acid, glutamic acid, lysine or arginine.
   (ii) R51 is substituted by alanine, glycine, leucine, isoleucine, valine, asparagine, serine or threonine; F54 is substituted by glycine, alanine, valine, leucine, isoleucine, methionine, or proline; H55 is substituted by glycine, alanine, valine, leucine, isoleucine, methionine, proline, serine, threonine, asparagine, tyrosine, cysteine, aspartic acid, glutamic acid, lysine or arginine; or
   (iii) D178 is substituted by tryptophan and one or more of S172, R257 and R271 are substituted by aspartic acid or glutamic acid
b.) a peroxidase being at least 30%, at least 50%, at least 70% or even at least 75% to SEQ ID NO: 2:
c) a peroxidase being at least 30%, at least 70%, at least 90% or even at least 98% identity to SEQ ID NO: 3:
d) and combinations thereof;
and a cleaning and/or treatment material.

In one aspect, said first composition may comprise a cleaning and/or treatment material selected from the group consisting of surfactants, builders, chelating agents, dye transfer inhibiting agents, dispersants, additional enzymes, and enzyme stabilizers, catalytic materials, bleaching agents, polymeric dispersing agents, clay soil removal/anti-redeposition agents, brighteners, suds suppressors, dyes, perfumes, structure elasticizing agents, fabric softeners, carriers, hydrotropes, processing aids, solvents, pigments, hueing agents, photobleaches, structurants, monosaccharides, oligosaccharides, polysaccharides, a peroxidase enhancer and mixtures thereof.

In one aspect, said first composition may comprise an additional enzyme and/or a bleaching agent selected from the group consisting of hydrogen peroxide, hydrogen peroxide, sodium percarbonate, sodium perborate and mixtures thereof.

In one aspect, said first composition may comprise an additional enzyme that is capable of generating hydrogen peroxide when said enzyme interacts with a substrate.

In one aspect, said first composition may comprise an additional enzyme that is selected from the group consisting of hemicellulases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccase, amylases, or mixtures thereof.

In one aspect, said first composition may comprise an additional enzyme that is selected from the group consisting of: lipases, alpha-amylases; serine proteases; endoglucanases; oxidases; and mixtures thereof.

In one aspect, said first composition may comprise, based on weight of said composition, from about 0.000025% to about 1.7%, from about 0.0001% to about 1.0%, from about 0.005% to about 0.3%, or even from about 0.005% to about 0.1% of an oxidase.

In one aspect, said first composition may comprise an oxidase that comprises an oxidase selected from the group consisting of carbohydrate: acceptor oxidoreductases, cellobiose dehydrogenase, cellobiose quinone oxidoreductase and mixtures thereof.

In one aspect, said first composition may comprise, based on weight of said composition, from about 0.000025% to about 1.7%, from about 0.00001% to about 1.0%, from about 0.005% to about 0.3%, or even from about 0.005% to about 0.1% of an endoglucanase.

In one aspect, said first composition may comprise an endo-β-1,4-glucanase selected from the group consisting of glycosyl hydrolase families 5, 7, 12, 16, 44 or 74, and mixtures thereof.

In one aspect, said first composition may be a liquid laundry detergent composition, that may comprise endoglucanase and/or oxidase each of which may be present at levels of from about 0.00005 wt % to about 0.5 wt % (i.e. from 0.05 to 500 mg active enzyme per 100 g of liquid laundry detergent composition), based on total liquid laundry composition weight.

In one aspect, said first composition may be a laundry additive composition, that may comprise endoglucanase and/or oxidase each of which may be present at levels of from about 0.0005 wt % to about 1.7 wt % (i.e. from 0.5 to 1700 mg active enzyme per 100 g of laundry additive composition), based on total laundry additive composition weight.

In one aspect, said first composition may be a dry laundry detergent composition, that may comprise endoglucanase and/or oxidase each of which may be present at levels of from about 0.000025 wt % to 0.5 wt % (i.e. from 0.025 to 500 mg active enzyme per 100 g of dry laundry composition), based on total dry laundry composition weight.

In one aspect, said first composition may comprise, from about 0.1% to about 70%, based on total composition weight, of a material selected from the group consisting of monosaccharides, oligosaccharides, polysaccharides and mixtures thereof.

In one aspect, said first composition may be a liquid laundry detergent composition, that may comprise polysaccharide, oligosaccharide or monosaccharide sources of reducing sugar that may be present at levels of from about 0.1 wt % to about 10 wt %, based on total liquid laundry composition weight.

In one aspect, said first composition may be a laundry additive composition, that may comprise polysaccharide, oligosaccharide or monosaccharide sources of reducing sugar that may be present at levels of from about 0.1 wt % to about 30 wt %, based on total laundry additive composition weight.

In one aspect, said first composition may be a dry laundry detergent composition, that may comprise polysaccharide, oligosaccharide or monosaccharide sources of reducing sugar that may be present at levels of from about 0.1 wt % to 30 wt %, based on total dry laundry composition weight.

In one aspect, said first composition may comprise a bleaching agent selected from hydrogen peroxide, sodium percarbonate, sodium perborate, and mixtures thereof.

In one aspect, said first composition may comprise, based on total composition weight, from about 0.05% to about 80%, from about 0.1% to about 50%, from about 0.2% to about 30% or even from about 0.5% to about 20% of said bleaching agent selected from hydrogen peroxide, sodium percarbonate, sodium perborate, and mixtures thereof.

In one aspect, said first composition may be a liquid laundry detergent that may comprise, based on total liquid laundry detergent composition weight, from about 0.00005% to about 0.5% (i.e. from 0.05 to 500 mg active enzyme per 100 g of composition) of a suitable peroxidase.

In one aspect, said first composition may be a laundry additive composition that may comprise, based on total laundry additive composition weight, from about 0.0005% to about 20% (i.e. from 0.5 to 20000 mg active enzyme per 100 g of composition) of a suitable peroxidase.

In one aspect, said first composition may be a dry laundry detergents that may comprise, based on total dry laundry composition weight, from about 0.00005% to about 0.5% (i.e. from 0.05 to 500 mg active enzyme per 100 g of composition) of a suitable peroxidase.

In one aspect, said first composition may be a product that may comprise: a multi compartment container, such a dual compartment bottle; a detergent composition that comprises a suitable peroxidase, for example a suitable peroxidase as disclosed in the present specification; hydrogen peroxide and a means for bringing said detergent and hydrogen peroxide into contact when said detergent and hydrogen peroxide are dispensed, said detergent and hydrogen peroxide being contained in separate compartments of said container.

In one aspect, said first composition may be a liquid laundry detergent that may comprise, based on total liquid laundry composition weight, less than 50%, less than 40%, less than 30%, less than 20%, less than 10% or even less than 5% solvent, for example water.

In one aspect, said first composition may be a dry laundry detergent that may comprise, based on total dry laundry composition weight, less than 50%, less than 40%, less than 30%, less than 20%, less than 10% or even less than 5% filler, for example a material selected from the group consisting of metal sulfate, such as sodium sulfate; metal carbonate, such as sodium carbonate; builder such as zeolite A and/or sodium tripolyphosphate; and mixtures thereof.

In one aspect, said first composition may comprise any combination of parameters and levels of ingredients disclosed in the present specification.

Suitable peroxidases can be produced in accordance with the teachings of the present specification including the following teachings:

Variants of Wild-Type Class II Peroxidase from Coprinus cinereus

SEQ ID NO:1 is the amino acid sequence of a wild-type Class II peroxidase endogenous to the inky cap mushroom Coprinus cinereus. Variants of this enzyme suitable for use in the present composition can be prepared using standard biochemical techniques as described in detail in U.S. Pat. No. 5,968,883. U.S. Pat. No. 5,968,883 also describes mutations to SEQ ID NO:1 which can optionally be combined with the substitutions of the current invention to further enhance the thermal and oxidative stability of the peroxidase in detergent washing solutions.

MsP1 Peroxidase (Dy-P Peroxidase D) from Marasmius scorodonius and Variants Thereof

SEQ ID NO:2 is the amino acid sequence of the Dy-P peroxidase D from Marasmius scorodonius. The wild-type can be isolated from the Marasmius scorodonius strain (CBS 137.86), available from the Dutch “Centraalbureau voor Schimmelcultures”, Baarn, Netherlands, using the protocol described in M. Scheibner et al, Appl Microbiol Biotechnol, 2008, volume 77, pp 1241-1250. Variants can be produced according to standard biochemical techniques as described above for variants of Coprinus cinereus peroxidase.

Versatile Peroxidase PerVP01 from Pleurotus eryngii and Variants Thereof

SEQ ID NO:3 is the amino acid sequence of the Versatile peroxidase from the white-rot fungus Pleurotus eryngii. The wild-type can be isolated from Pleurotus eryngii strain CBS 613.91, available from the culture collection, Department of Chemical Engineering, University of Santiago de Compostela, Santiago de Compostela, Spain, using the protocol given in F. J. Ruiz-Duenas, Mol Microbiol., 1991, volume 31, pp 223-235. Variants can be produced according to standard biochemical techniques as described in F. J. Ruiz-Duenas, Biochemistry, 2008, volume 47, pp 1685-1695, and F. J. Ruiz-Duenas, Biochemistry, 2007, volume 46, pp 66-77.

### Cleaning and Treatment Materials

While not essential for the purposes of the present invention to obtain the basic benefits of the present invention, the non-limiting list of materials illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, polymers, photobleaches, chelating agents, dye transfer inhibiting agents, dispersants, additional enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents, hueing agents, structurants, monosaccharides, oligosaccharides, polysaccharides, peroxidase enhancers and/or pigments. In addition to the disclosure below, suitable examples of such other materials and levels of use are found in U.S. Pat. Nos. 5,576,282, 6,306,812 B1 and 6,326,348 B1 that are incorporated by reference.

As stated, the adjunct ingredients are not required to obtain the basic benefits of Applicants' compositions. Thus, certain embodiments of Applicants' compositions do not contain one or more of the following materials: surfactants, builders, polymers, photobleaches, chelating agents, dye transfer inhibiting agents, dispersants, additional enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents, hueing agents, structurants, monosaccharides, oligosaccharides, polysaccharides, peroxidase enhancers and/or pigments. However, when one or more of the aforementioned materials are present, such one or more materials may be present as detailed below:

Peroxidase Enhancers—The composition may comprise a peroxidase enhancer. Several classes of peroxidase or oxidase enhancers have been described, see U.S. Pat. Nos. 5,700,769; and 5,965,510. Particular interest has been directed to the enhancer phenothiazine-10-propionate, as described in U.S. Pat. Nos. 5,451,337 and 5,445,755. However, the described classes of enhancers only enhance the peroxidase activity when hydrogen peroxide is added to the bleaching composition. Other enhancers are capable of enhancing the bleaching activity of the peroxidase enzyme with the addition of molecular oxygen, i.e. hydrogen peroxide does not need to be present for obtaining the desired enhancement of the oxidizing activity of peroxidases. Several classes of compounds can be envisaged which deliver the capability of enhancing the peroxidase activity, in the presence of only oxygen. Non-limiting examples include: the enhancer having the formula:

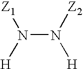

wherein: wherein Z₁, is any organic group e. g. (substituted)—(hetero) (polycyclic)-aromatic, substituted (cyclo)-alkyl containing hetero atoms, and Z₂ is electron withdrawing group, selected from the group consisting of optionally substituted alkyl/(hetero)aryl- -sulfone, sulfoxide, -sulfonate, -carbonyl, -oxalyl, -amidoxalyl, 5 hydrazidoxalyl, -carboxyl and esters and salts thereof, amidyl, -hydrazidyl, nitrile.

In one aspect, the enhancer may have the formula:

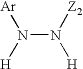

wherein Z₂ is as defined before and Ar is an optionally substituted aromatic or heteroaromatic group e.g. phenyl, phenyl substituted with halogen(s), alkoxy, alkyl, (alkyl)amino substituents, pyridinyl, alkyl-pyridinyl, furanyl. In one aspect, enhancer compounds may have the generic structures:

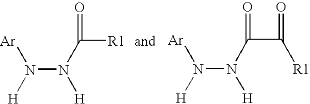

wherein the Ar group is as defined before and R1 is an optionally substituted alkyl, oxyalkyl, aryl, arylhydrazide, arylhydrazine or oxyaryl group of interest are derivatives of 2′-phenylbenzohydrazide, having the following structure:

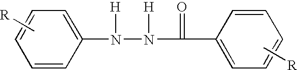

2-phenylhydrazide oxalate, having the following structure:

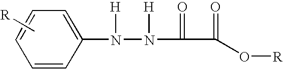

and oxalic acid bis(2-phenylhydrazide), having the following structure:

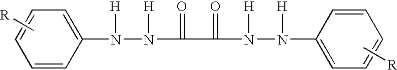

with R representing one or more substitutions independently selected from hydrogen, halogen(s), alkoxy, alkyl, (alkyl) amino, carbonate, carbonate ester, sulphonate, sulphonamide. Examples of such enhancers are: 2′-phenylbenzohydrazide; 2′-m-tolylbenzohydrazide; 2-p-tolylbenzohydrazide; 2′-o-tolylbenzohydrazide; Ethyl[2-(m-tolyl)]hydrazide oxalate; Ethyl[2-(p-tolyl)]hydrazide oxalate; Ethyl[2-(o-tolyl)]hydrazide oxalate; Oxalic acid bis(2-phenylhydrazide); Oxalic acid bis(2-m-tolylhydrazide); and Oxalic acid bis(2-o-tolylhydrazide). The enhancers disclosed herein can be added to compositions in any suitable form, i.e. the form of a granular composition, a liquid or slurry of the enhancer, with carrier, or a coating.

When employed, peroxidase enhancers may be used in compositions, based on total composition weight, at levels of from about 0.00025% to about 20%. In one aspect, liquid laundry detergent compositions, may employ such enhancers at levels from about 0.005% to about 5% based on total liquid laundry detergent composition weight. In one aspect, laundry additive compositions may employ enhancers at levels of from about 0.0005% to about 20% based on total laundry additive composition weight. In one aspect, dry laundry detergents, may employ such enhancers at levels of from about 0.00025% to about 5% based on total dry laundry detergent weight.

Bleaching Agents—The compositions disclosed herein may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject composition. Examples of suitable bleaching agents include:

(1) photobleaches

(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone®, and mixtures thereof. Suitable percarboxylic acids include hydrophobic and hydrophilic peracids having the formula R—(C═O)O—O—M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counter ion, for example, sodium, potassium or hydrogen;

(3) sources of hydrogen peroxide, for example, hydrogen peroxide solution, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof.

When employed, inorganic perhydrate salts may be incorporated into compositions at levels of from about 0.05% to about 80%, or about 1% to about 30% based on total composition weight and may be incorporated into such compositions as a crystalline solid that may be coated. When employed in laundry additive compositions, inorganic perhydrate salts may be incorporated into such laundry additive compositions at levels of from about 0.1 wt % to about 80% based on total laundry additive composition weight and from about 0.1 wt % to 50 wt % based on total dry laundry detergent composition weight when employed in dry laundry detergent compositions. Suitable coatings include, inorganic salts such as alkali metal silicate, carbonate or borate salts or mixtures thereof, or organic materials such as water-soluble or dispersible polymers, waxes, oils or fatty soaps; and

(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). While any suitable bleach activator may be employed, in one aspect of the invention the subject composition may comprise NOBS, TAED or mixtures thereof.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The compositions disclosed herein may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

Builders—The compositions disclosed herein may comprise one or more detergent builders or builder systems. Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The compositions disclosed herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The compositions disclosed herein may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The compositions disclosed herein can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions disclosed herein can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—The compositions disclosed herein can comprise one or more enzymes which provide cleaning performance and/or fabric care benefits or other benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccase, amylases, or mixtures thereof. A typical combination is an enzyme cocktail that may comprise, for example, a protease and lipase in conjunction with amylase. When present, in certain aspects of the compositions disclosed herein the aforementioned additional enzymes may be present, based on total weight of said composition, at levels of from about 0.00005% to about 20.0%, from about 0.0001% to about 1.0%, from about 0.005% to about 0.3%, or even from about 0.005% to about 0.1%.

Auxiliary Enzymatic System which Produces Peroxide In Situ

In certain embodiments of the invention, the compositions disclosed herein may comprise an auxiliary enzymatic system which can generate hydrogen peroxide, predominantly in the wash solution, thus removing or reducing the need to formulate hydrogen peroxide or persalt in the composition. Such system may be especially beneficial in liquid detergent compositions as such compositions do not usually comprise hydrogen peroxide or persalts due to instability of the bleaching agent and/or instability of other raw materials during storage.

In one aspect, the auxiliary enzymatic system which produces peroxide in situ comprises an oxidase enzyme which, not being bound by theory, Applicants believe catalyses the formation of hydrogen peroxide on contact with reducing sugars, such as the reducing ends of amorphous cellulose present on cotton fabrics washed in the detergent composition. In one aspect, the auxiliary enzymatic system comprises a mixture of said oxidase and an endoglucanase enzyme. Without wishing to be bound by theory, the Applicants believe that the endoglucanase acts on the amorphous cellulose present on cotton fabrics assisting in its fragmentation into reducing oligosaccharides. In another aspect, the auxiliary enzymatic system comprises a mixture of said oxidase and a source of reducing sugar, for example a polysaccharide, oligosaccharide or monosaccharide.

Examples of suitable oxidases include but are not limited to: oxidases, for example carbohydrate:acceptor oxidoreductases, cellobiose dehydrogenase, cellobiose quinone oxidoreductase and mixtures thereof. An example of a carbohydrate:acceptor oxidoreductases is the carbohydrate:acceptor oxidoreductase endogenous to Microdochium nivale as described in F. Xu et al, Eur J. Biochem, 2001, volume 268, pp 1136-1142.

Examples of suitable endoglucanases include, but are not limited to, those having endo beta 1,4-glucanase activity and a structure which does not comprise a class A Carbohydrate Binding Module (CBM). In one aspect, the cellulase may comprise a glycosyl hydrolase having enzymatic activity towards amorphous cellulose substrates, wherein the glycosyl hydrolase may be selected from GH families 5, 7, 12, 16, 44 or 74. In one aspect, the cellulase may comprise a glycosyl hydrolase selected from GH family 5. In one aspect, the cellulase may comprise Celluclean®, supplied by Novozymes, Bagsvaerd, Denmark. In one aspect, the cellulase may comprise a glycosyl hydrolase having enzymatic activity towards both xyloglucan and amorphous cellulose substrates, wherein the glycosyl hydrolase may be selected from GH families 5, 12, 44 or 74. In one aspect, the glycosyl hydrolase selected from GH family 44, may comprise XYG1006 enzyme that may be endogenous to Paenibacillus polyxyma as disclosed in U.S. Pat. No. 6,815,192.

Examples of suitable polysaccharide, oligosaccharide or monosaccharide sources of reducing sugar are glucose, xylose, fructose, cellobiose, maltose, lactose, galactose, cellulose- and starch-based polymers.

Enzyme Stabilizers—Enzymes can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

Suitable catalytic metal complexes include Tinocat® TRS, commercially available from Ciba Specialty Chemicals, Basel, Switzerland.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

### Processes of Making Compositions

The compositions of the present invention can be formulated into any suitable form and prepared by any process chosen by the formulator, non-limiting examples of which are described in Applicants' examples and in U.S. Pat. No. 4,990,280; U.S. 20030087791A1; U.S. 20030087790A1; U.S. 20050003983A1.

### Method of Use

In one aspect, a method for cleaning and/or treating a situs inter alia a surface or fabric is disclosed. Such method includes the steps of optionally washing and/or rinsing said surface or fabric, contacting said surface or fabric with a composition of the present invention in neat or diluted form such as in a wash liquor and then optionally washing and/or rinsing said surface or fabric. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method may comprise the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution may have in one aspect a pH of from about 7.5 to about 10.5 or even a pH of from about 8 to about 10.5. The compositions may be employed at concentrations of from about 60 ppm to about 15,000 ppm in solution. The water temperatures typically range from about 5° C. to about 90° C. The water to fabric ratio is typically from about 1:1 to about 50:1.

A cleaned and/or treated situs is also disclosed. Said cleaning and/or treatment may be achieved by the cleaning and/or treatment method disclosed herein.

### Examples

Unless otherwise indicated, materials can be obtained from Aldrich, P.O. Box 2060, Milwaukee, Wis. 53201, USA.

The compositions are made by combining the listed ingredients in the listed proportions (weight % of active material except where noted otherwise).

### Examples 1-8

Liquid laundry detergent compositions suitable for front-loading automatic washing machines. Current typical usage concentrations for these products range from 3-10 g product per liter of wash water, e.g. an 80 g dose for 15 L wash volume. However, in the future with increasing product compaction, it would be feasible to reduce the level of water in these compositions and increase the quantities of the other constituents so as to achieve the same amounts of active ingredients in the wash at a lower dosage.

| | Composition | | | | | | | |
|---|---|---|---|---|---|---|---|---|
| | (wt % of composition) | | | | | | | |
| Ingredient | 1 | 2 | 3 | 4 | 5 | 6 | 7 | 8 |
| Alkylbenzene sulfonic acid | 7 | 11 | 4.5 | 1.2 | 1.5 | 12.5 | 5.2 | 4 |
| with average aliphatic chain | | | | | | | | |
| length C11-12 | | | | | | | | |
| Sodium C₁₂₋₁₄ alkyl ethoxy- | 2.3 | 3.5 | 4.5 | 4.5 | 7 | 18 | 1.8 | 2 |
| 3-sulfate | | | | | | | | |
| C₁₄₋₁₅ alkyl-8-ethoxylate | 5 | 8 | 2.5 | 2.6 | 4.5 | 4 | 3.7 | 2 |
| C₁₂ alkyl dimethyl amine | — | — | 0.2 | — | — | — | — | — |
| oxide | | | | | | | | |
| C₁₂₋₁₄ alkyl hydroxyethyl | — | — | — | 0.5 | — | — | — | — |
| dimethyl ammonium chloride | | | | | | | | |
| C₁₂₋₁₈ Fatty acid | 2.6 | 4 | 4 | 2.6 | 2.8 | 11 | 2.6 | 1.5 |
| Citric acid | 2.6 | 3 | 1.5 | 2 | 2.5 | 3.5 | 2.6 | 2 |
| Random graft co-polymer¹ | 1 | 0.2 | 1 | 0.4 | 0.5 | 2.7 | 0.3 | 1 |
| A compound having the | 0.4 | 2 | 0.4 | 0.2 | 1.5 | 1.8 | 0.7 | 0.3 |
| following general structure: | | | | | | | | |
| bis((C₂H₅O)(C₂H₄O)n)(CH₃)—N⁺—CₓH₂ₓ—N⁺—(CH₃)-bis((C₂H₅O)(C₂H₄O)n), | | | | | | | | |
| wherein n = from 20 to 30, | | | | | | | | |
| and x = from 3 to 8, or | | | | | | | | |
| sulfated or sulfonated | | | | | | | | |
| variants thereof | | | | | | | | |
| Diethylenetriaminepenta(methylenephosphonic) | 0.2 | 0.3 | — | — | 0.2 | — | 0.2 | 0.3 |
| acid | | | | | | | | |
| Hydroxyethane diphosphonic | — | — | 0.45 | — | — | 1.5 | — | 0.1 |
| acid | | | | | | | | |
| Brightener Tinopal(R) CBS-X | 0.1 | 0.2 | 0.1 | — | — | 0.2 | 0.05 | 0.1 |
| Solvents (1,2 propanediol, | 3 | 4 | 1.5 | 1.5 | 2 | 4.3 | 2 | 1.5 |
| ethanol), stabilizers | | | | | | | | |
| Hydrogenated castor oil | 0.4 | 0.4 | 0.3 | 0.1 | 0.3 | — | 0.4 | 0.5 |
| derivative structurant | | | | | | | | |
| Boric acid | 1.5 | 2.5 | 2 | 1.5 | 1.5 | 0.5 | 1.5 | 1.5 |
| Na formate | — | — | — | 1 | — | — | — | — |
| Reversible protease inhibitor² | — | — | 0.002 | — | — | — | — | — |
| Perfume | 0.5 | 0.7 | 0.5 | 0.5 | 0.8 | 1.5 | 0.5 | 0.8 |
| Protease (Purafect ® Prime)* | 20 | 15 | 17 | 12 | 6 | 16 | 9.0 | 6.0 |
| Amylase (Natalase ®)* | 4.0 | 2.9 | 2.0 | — | 1.0 | 7.9 | 1.8 | 2.8 |
| Mannanase (Mannaway ®)* | 0.5 | 1.0 | 0.5 | — | — | 1.0 | 0.4 | — |
| Xyloglucanase XYG1006³* | 7.0 | 4.0 | 3.0 | 3.0 | — | 8.0 | 2.5 | 4.0 |
| (mg aep/100 g detergent) | | | | | | | | |
| oxidase⁴* | 2.8 | 8.0 | 12.0 | 16.0 | 20.0 | 3.1 | 4.3 | — |
| Peroxidase⁵* | 5.0 | 3.3 | 6.4 | 7.3 | 1.1 | 2.2 | 4.4 | 3.1 |

| | |
|---|---|
| Buffers (sodium hydroxide, | To pH 8.2 |
| Monoethanolamine) | |
| Water and minors (antifoam, | To 100% |
| aesthetics) | |

### Examples 9-16

Liquid laundry detergent compositions suitable for top-loading automatic washing machines. Current typical usage concentrations for these products range from 0.2-5 g product per liter of wash water, e.g. an 50 g dose for 64 L wash volume. However, in the future with increasing product compaction, it would be feasible to reduce the level of water in these compositions and increase the quantities of the other constituents so as to achieve the same amounts of active ingredients in the wash at a lower dosage.

| | Composition | | | |
|---|---|---|---|---|
| | (wt % of composition) | | | |
| Ingredient | 9 | 10 | 11 | 12 |
| C₁₂₋₁₅ Alkylethoxy(1.8)sulfate | 20.1 | 15.1 | 20.0 | 15.1 |
| C_{11.8} Alkylbenzene sulfonate | 2.7 | 2.0 | 1.0 | 2.0 |
| C₁₆₋₁₇ branched alkyl sulfate | 6.5 | 4.9 | — | 4.9 |
| C₁₂₋₁₄ Alkyl-9-ethoxylate | 0.8 | 0.8 | 0.8 | 0.8 |
| C₁₂ dimethylamine oxide | — | — | 0.9 | — |
| Citric acid | 3.8 | 3.8 | 3.8 | 3.8 |
| C₁₂₋₁₈ fatty acid | 2.0 | 1.5 | 2.0 | 1.5 |
| Borax | 3.0 | 3.0 | — | — |
| Na & Ca formate | 0.2 | 0.2 | — | 0.2 |
| A compound having the following general | 1.6 | 1.6 | 3.0 | 1.6 |
| structure: bis((C₂H₅O)(C₂H₄O)n)(CH₃)—N⁺—CₓH₂ₓ—N⁺—(CH₃)-bis((C₂H₅O)(C₂H₄O)n), | | | | |
| wherein n = from | | | | |
| 20 to 30, and x = from 3 to 8, or sulphated | | | | |
| or sulphonated variants thereof | | | | |
| Random graft co-polymer¹ | 0.4 | 0.2 | 1.0 | 0.5 |
| Diethylene triamine pentaacetic acid | 0.4 | 0.4 | 0.4 | 0.4 |
| Brightener (Tinopal AMS-GX) | 0.2 | 0.2 | 0.2 | 0.2 |
| Soil release polymer Texcare 240N | — | — | — | 1.0 |
| Ethanol | 2.6 | 2.6 | 2.6 | 2.6 |
| Propylene glycol | 4.6 | 4.6 | 4.6 | 4.6 |
| Diethylene glycol | 3.0 | 3.0 | 3.0 | 3.0 |
| Polyethylene glycol | 0.2 | 0.2 | 0.2 | 0.2 |
| Monoethanolamine | 2.7 | 2.7 | 2.7 | 2.7 |
| Dye | 0.01 | 0.01 | 0.01 | |
| Perfume | 0.5 | 0.5 | 0.5 | 0.5 |
| Protease (Purafect ® Prime)* | 15.0 | 20.0 | 7.0 | 15.0 |
| Amylase (Natalase ®)* | 5.0 | 6.0 | 4.9 | 3.3 |
| Mannanase (Mannaway ®)* | 1.5 | — | — | — |
| Pectate Lyase (Pectawash ®)* | 13 | — | — | — |
| Xyloglucanase XYG1006³* | 5 | 13 | 2 | 15 |
| (mg aep/100 g detergent) | | | | |
| oxidase⁴* | 12 | 32 | 23 | 12 |
| Peroxidase⁵* | 5.0 | 4.4 | 2.1 | 4.9 |
| NaOH | to pH 8.3 | to pH 8.3 | to pH 8.3 | to pH 8.3 |
| Water | balance | balance | balance | balance |
| | Composition | | | |
| | (wt % of composition) | | | |
| Ingredient | 13 | 14 | 15 | 16 |
| C₁₂₋₁₅ Alkylethoxy(1.8)sulfate | 13.7 | 16.7 | 10.0 | 9.9 |
| C_{11.8} Alkylbenzene sulfonate | 5.5 | 5.6 | 3.0 | 3.9 |
| C₁₆₋₁₇ branched alkyl sulfate | 3.0 | 9.0 | 2.0 | — |
| C₁₂₋₁₄ Alkyl-9-ethoxylate | 8.0 | 1.5 | 0.3 | 11.5 |
| Citric acid | 3.5 | 3.5 | 2.0 | 2.1 |
| C₁₂₋₁₈ fatty acid | 4.5 | 2.3 | — | 0.9 |
| Borax | 2.0 | 3.0 | 3.0 | 3.3 |
| Na & Ca formate | 0.2 | — | 0.7 | — |
| A compound having the following general | 2.0 | 1.6 | 1.3 | 1.2 |
| structure: bis((C₂H₅O)(C₂H₄O)n)(CH₃)—N⁺—CₓH₂ₓ—N⁺—(CH₃)-bis((C₂H₅O)(C₂H₄O)n), | | | | |
| wherein n = from | | | | |
| 20 to 30, and x = from 3 to 8, or sulphated | | | | |
| or sulphonated variants thereof | | | | |
| Random graft co-polymer¹ | 0.6 | 1.0 | 0.8 | 1.0 |
| Diethylene triamine pentaacetic acid | 0.2 | 0.3 | 0.8 | — |
| Brightener (Tinopal AMS-GX) | 0.2 | 0.3 | 0.1 | — |
| Brightener (Tinopal CBS-X) | — | 0.1 | — | 0.2 |
| Ethanol | 1.8 | 3.0 | 1.3 | — |
| Propylene glycol | 3.0 | 4.0 | 2.5 | — |
| Diethylene glycol | 3.0 | 2.7 | 3.6 | — |
| Polyethylene glycol | 0.1 | 0.3 | 0.1 | 1.4 |
| Monoethanolamine | 4.7 | 3.3 | 1.7 | 0.4 |
| Triethanolamine | — | — | — | 0.9 |
| Dye | 0.01 | 0.01 | 0.01 | 0.0 |
| Perfume | 0.7 | 0.7 | 0.8 | 0.6 |
| Protease (Purafect ® Prime)* | 18.0 | 20.0 | 7.0 | 9.0 |
| Amylase (Natalase ®)* | 3.9 | 4.0 | — | — |
| Amylase (Stainzyme ®)* | — | — | — | 11.0 |
| Mannanase (Mannaway ®)* | — | 0.7 | — | — |
| Pectate Lyase (Pectawash ®)* | — | 20 | — | — |
| Xyloglucanase XYG1006³* | 20 | — | 2 | 20 |
| (mg aep/100 g detergent) | | | | |
| oxidase⁴* | 9 | 2.3 | 4.4 | 29 |
| Peroxidase⁵* | 6.9 | 4.9 | 3.2 | 1.9 |
| NaOH | to pH 8.3 | to pH 8.3 | to pH 8.3 | to pH 8.5 |
| Water | balance | balance | balance | balance |

### Examples 17-21

Laundry additive compositions designed to be used in conjunction with other laundry detergent compositions.

Current typical usage concentrations for these products range from 5-50 g product dosed in addition to another detergent composition. Typical wash volumes range from 5 liters to 80 liters. In future, with increasing product compaction, it would be feasible to reduce the level of sodium carbonate in these compositions and increase the quantities of the other constituents so as to achieve the same amounts of active ingredients in the wash at a lower dosage.

| Ingredient | 17 | 18 | 19 | 20 | 21 |
|---|---|---|---|---|---|
| Sodium percarbonate | 33.0 | — | 18.0 | 53.0 | 33.0 |
| Tetraacetylethylenediamine | 15.0 | — | 4.4 | — | — |
| Sodium nonanoyloxybenzenesulfonate | — | — | — | — | 6.0 |
| Acrylic Acid/Maleic Acid Copolymer | 2.0 | 2.5 | — | 1.3 | — |
| Hydroxyethane diphosphonic acid | 1.3 | 0.2 | 1.2 | 0.7 | — |
| Carboxymethyl cellulose | — | 1.1 | 0.5 | — | — |
| Polyvinylpyrrolidone (PVP) | — | — | 0.1 | — | — |
| Sodium linear alkylbenzenesulfonate | 1.2 | 2.2 | 3.7 | 7.0 | — |
| Nonionic (AE7) surfactant | 0.5 | 1.1 | 0.4 | 2.0 | 0.1 |
| Brightener (Tinopal CBS-X) | 0.1 | — | 0.07 | 0.12 | — |
| Soil release agent (Repel-o-Tex ® SF) | — | — | 0.56 | 0.3 | — |
| Mannanase (Mannaway ®)* | 15 | — | 10 | 10 | — |
| Protease (Savinase ®)* | — | — | 15 | 25 | — |
| Endoglucanase (Celluclean ®)* | 3.0 | 16 | 15 | 8 | 15 |
| oxidase⁴* | — | 22 | — | — | — |
| Peroxidase⁵* | 5 | 12 | 3 | 2 | 3 |
| Peroxidase enhancer (Phenothiazine- | 0.2 | — | 0.2 | 0.9 | 0.1 |
| 10-propionate) | | | | | |
| Sodium carbonate | Balance | Balance | Balance | Balance | Balance |

### Examples 22-26

Granular dry laundry detergent compositions designed for use in washing machines or hand washing processes.

Current typical usage concentrations for these products range from 0.5-20 g product per liter of wash water, e.g. an 80 g dose for 15 L wash volume. However, in the future with increasing product compaction, it would be feasible to reduce the level of sodium sulfate and/or sodium carbonate in these compositions and increase the quantities of the other constituents so as to achieve the same amounts of active ingredients in the wash at a lower dosage.

| | 22 | 23 | 24 | 24 | 25 | 26 |
|---|---|---|---|---|---|---|
| Sodium linear | 10 | 12 | 7 | 6 | 12 | 13 |
| alkylbenzenesulfonate with | | | | | | |
| average aliphatic chain | | | | | | |
| length C11-12 | | | | | | |
| Sodium C₁₂₋₁₄ alkyl ethoxy- | 2 | 2.0 | 1.2 | 1.3 | | |
| 3-sulfate | | | | | | |
| C12-15 alcohol ethoxylate | 1.6 | 1.2 | 1.9 | 3.2 | 0.5 | 1.2 |
| with average 7 moles of | | | | | | |
| ethoxylation | | | | | | |
| STPP | 1 | — | — | — | — | — |
| Zeolite | — | 1 | — | 1 | 4 | 1 |
| Silicate 2.0R | 4 | 5 | 2 | 3 | 3 | 5 |
| Sodium Carbonate | 9 | 20 | 10 | 17 | 5 | 23 |
| Polyacrylate (MW 4500) | 1 | 0.6 | 1 | 1 | 1.5 | 1 |
| Carboxymethyl cellulose | 1 | 5.3 | — | — | — | 2.3 |
| Fluorescent Brightener(s) | 0.16 | 0.06 | 0.16 | 0.18 | 0.16 | 0.16 |
| Diethylenetriamine | — | — | 0.6 | 0.25 | 0.6 | 0.6 |
| pentaacetic acid | | | | | | |
| Tetrasodium S,S- | 0.3 | — | — | — | — | — |
| Ethylenediamine | | | | | | |
| disuccinate | | | | | | |
| Hydroxyethane | 0.1 | 0.4 | — | — | — | 0.2 |
| diphosphonic acid | | | | | | |
| Bayhibit ® AM | — | — | 0.2 | 0.2 | 0.3 | 0.1 |
| MgSO₄ | 1 | 1 | 1 | 0.5 | 1 | 1 |
| Sodium percarbonate | 10 | 12 | 2 | — | — | 1 |
| Protease (Savinase ®)* | 13 | 10 | 8.2 | 5.5 | 10.4 | 20.0 |
| Amylase (Stainzyme ® | 15.2 | 12.9 | — | 2.2 | 7.2 | — |
| Plus)* | | | | | | |
| Lipase (Lipex ®)* | — | 5.0 | — | 2.2 | — | 1.2 |
| Lactose | — | — | — | 25 | — | — |
| Endoglucanase | 1.5 | 5.4 | 1.5 | | 22 | 15.5 |
| (Celluclean ®)* | | | | | | |
| Carbohydrate oxidase⁴* | — | — | — | 17 | 54 | 32 |
| Peroxidase⁵* | 9 | 12 | 7 | 45 | 6 | 9 |
| Peroxidase enhancer | 0.3 | — | 0.1 | 0.3 | — | 0.2 |
| (Phenothiazine-10- | | | | | | |
| propionate) | | | | | | |
| Sulfate/Moisture/perfume | Balance | Balance to | Balance to | Balance | Balance | Balance |
| | to 100% | 100% | 100% | to 100% | to 100% | to 100% |

### Notes for Examples:

Surfactant ingredients can be obtained from Shell Chemicals, London, UK; Stepan, Northfield, Ill., USA; Huntsman, Huntsman, Salt Lake City, Utah, USA; Clariant, Sulzbach, Germany Zeolite A can be obtained from Industrial Zeolite (UK) Ltd, Grays, Essex, UK

Sodium tripolyphosphate can be obtained from Rhodia, Paris, France

Polymer ingredients can be obtained from BASF, Ludwigshafen, Germany

Citric acid can be obtained from DSM, Delft, Netherlands

Hydroxyethane diphosphonic acid can be obtained from Dow Chemical, Midland, Mich., USA

Bayhibit® AM can be obtained from Bayer, Leverkusen, Germany

Brighteners of the Tinopal® brand can be obtained from Ciba Specialty Chemicals, Basel, Switzerland

Enzymes of the Purafect® brand can be obtained from Genencor, Palo Alto, Calif., USA

Enzymes of the Savinase®, Lipex®, Celluclean®, Stainzyme®, Mannaway®, Natalase® and Pectawash® brands can be obtained from Novozymes, Bagsvaerd, Denmark.

Phenothiazine-10-propionate can be obtained as described in U.S. Pat. No. 5,451,337

Tetraacetylethylenediamine can be obtained from Warwick International, Mostyn, UK

Sodium nonanoyloxybenzenesulfonate can be obtained from Eastman, Batesville, Ark., USA

Diethylenetriaminepenta(methylenephosphonic) acid can be obtained from Dow Chemical, Midland, Mich., USA

Tetrasodium S,S-Ethylenediamine disuccinate can be obtained from Innospec, Ellesmere Port, UK

Hydrogenated castor oil derivative structurant can be obtained froElementis, Hightstown, N.J., USA

Soil release polymers of the Texcare® brand can be obtained from Clariant, Sulzbach, Germany

Soil release polymers of the Repel-o-tex® brand can be obtained from Rhodia, Paris, France

Sodium carbonate can be obtained from Solvay, Brussels, Belgium

Sodium percarbonate can be obtained from Solvay, Brussels, Belgium

Carboxymethyl cellulose is Finnfix® GDA and can be obtained from CPKelco, Arnhem, Netherlands
¹Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.
²Reversible Protease inhibitor of structure:

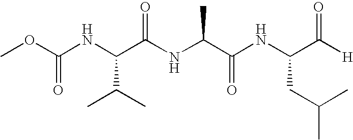

³Xyloglucanase is XYG1006 as disclosed in U.S. Pat. No. 6,815,192
⁴Carbohydrate:acceptor oxidoreductase from Microdochium nivale produced using the protocol given in F. Xu et al, Eur J. Biochem, 2001, volume 268, pp 1136-1142
⁵Peroxidase according to the invention
*Remark: all enzyme levels expressed as mg active enzyme protein per 100 g detergent composition
   The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising, based on total composition weight, from about 0.00005% to about 20.0% of a peroxidase selected from the group consisting of:
a.) a peroxidase being at least 70% identity to SEQ ID NO: 1 when said SEQ ID NO: 1 has one of the following groups of mutations:
(i) R51 is substituted by alanine, glycine, leucine, isoleucine, valine, asparagine, serine or threonine; F54 is substituted by glycine, alanine, valine, leucine, isoleucine, methionine, or proline; H55 is substituted by glycine, alanine, valine, leucine, isoleucine, methionine, proline, serine, threonine, asparagine, tyrosine, cysteine, aspartic acid, glutamic acid, lysine or arginine.
(ii) R51 is substituted by alanine, glycine, leucine, isoleucine, valine, asparagine, serine or threonine; F54 is substituted by glycine, alanine, valine, leucine, isoleucine, methionine, or proline; H55 is substituted by glycine, alanine, valine, leucine, isoleucine, methionine, proline, serine, threonine, asparagine, tyrosine, cysteine, aspartic acid, glutamic acid, lysine or arginine; or
(iii) D178 is substituted by tryptophan and one or more of S172, R257 and R271 are substituted by aspartic acid or glutamic acid
b.) a peroxidase being at least 30% identity to SEQ ID NO: 2:
c) a peroxidase being at least 30% identity to SEQ ID NO: 3:
d) and combinations thereof;
and a cleaning and/or treatment material.

2. The composition of claim 1, said composition comprising a cleaning and/or treatment material selected from the group consisting of surfactants, builders, chelating agents, dye transfer inhibiting agents, dispersants, additional enzymes, and enzyme stabilizers, catalytic materials, bleaching agents, polymeric dispersing agents, clay soil removal/anti-redeposition agents, brighteners, suds suppressors, dyes, perfumes, structure elasticizing agents, fabric softeners, carriers, hydrotropes, processing aids, solvents, pigments, hueing agents, photobleaches, structurants, monosaccharides, oligosaccharides, polysaccharides, a peroxidase enhancer and mixtures thereof.

3. The composition of claim 2, said composition comprising an additional enzyme and/or a bleaching agent selected from the group consisting of hydrogen peroxide, hydrogen peroxide, sodium percarbonate, sodium perborate and mixtures thereof.

4. The composition of claim 3, wherein said additional enzyme is capable of generating hydrogen peroxide when said enzyme interacts with a substrate.

5. The composition of claim 2, wherein said additional enzyme is selected from the group consisting of hemicellulases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccase, amylases, or mixtures thereof.

6. The composition of claim 5, wherein said additional enzyme is selected from the group consisting of:
a.) lipases
b.) alpha-amylases;
c.) serine proteases;
d.) endoglucanases
e.) oxidases; and
e.) mixtures thereof.

7. The composition of claim 5, comprising, based on weight of said composition, from about 0.000025% to about 1.7% of an oxidase.

8. The composition of claim 7 wherein said oxidase comprises an oxidase selected from the group consisting of carbohydrate: acceptor oxidoreductases, cellobiose dehydrogenase, cellobiose quinone oxidoreductase, and mixtures thereof.

9. The composition of claim 7 comprising, based on weight of said composition, from about 0.000025% to about 1.7% of an endoglucanase.

10. The composition of claim 9, wherein said endoglucanase comprises an endo-β-1,4-glucanase selected from the group consisting of glycosyl hydrolase families 5, 7, 12, 16, 44 or 74, and mixtures thereof.

11. The composition of claim 7, said composition comprising, from about 0.1% to about 70%, based on total composition weight, of a material selected from the group consisting of monosaccharides, oligosaccharides, polysaccharides and mixtures thereof.

12. The composition of claim 2, said composition comprising, based on total composition weight, from about 0.05% to about 80% of a bleaching agent selected from hydrogen peroxide, sodium percarbonate, sodium perborate, and mixtures thereof.

13. The composition of claim 4, said composition comprising a bleaching agent selected from hydrogen peroxide, sodium percarbonate, sodium perborate, and mixtures thereof.

14. The composition of claim 5, said composition comprising a bleaching agent selected from hydrogen peroxide, sodium percarbonate, sodium perborate, and mixtures thereof.

15. The composition of claim 6, said composition comprising a bleaching agent selected from hydrogen peroxide, sodium percarbonate, sodium perborate, and mixtures thereof.

16. The composition of claim 7, said composition comprising a bleaching agent selected from hydrogen peroxide, sodium percarbonate, sodium perborate, and mixtures thereof.

17. The composition of claim 8, said composition comprising a bleaching agent selected from hydrogen peroxide, sodium percarbonate, sodium perborate, and mixtures thereof.

18. The composition of claim 9, said composition comprising a bleaching agent selected from hydrogen peroxide, sodium percarbonate, sodium perborate, and mixtures thereof.

19. The composition of claim 10, said composition comprising a bleaching agent selected from hydrogen peroxide, sodium percarbonate, sodium perborate, and mixtures thereof.

20. The composition of claim 11, said composition comprising a bleaching agent selected from hydrogen peroxide, sodium percarbonate, sodium perborate, and mixtures thereof.

21. A method of cleaning and/or treating a situs comprising optionally washing and/or rinsing said situs, contacting said situs with a composition according to claim 1 in neat or diluted form and then optionally washing and/or rinsing said surface or fabric.

22. A situs treated according to the method of claim 21.


SEQUENCE LISTING (3 sequences)

SEQ ID NO: 1 - protein, 343 aa, Coprinus cinereus
QGPGGGGSVTCPGGQSTSNSQCCVWFDVLDDLQTNFYQGSKCESPVRKILRIVFHDAIGFSPALTAAGQFGGGGADGSIIAHSNIELAFPANGGLTDTVEALRAVGINHGVSFGDLIQFATAVGMSNCPGSPRLEFLTGRSNSSQPSPPSLIPGPGNTVTAILDRMGDAGFSPDEVVDLLAAHSLASQEGLNSAIFRSPLDSTPQVFDTQFYIETLLKGTTQPGPSLGFAEELSPFPGEFRMRSDALLARDSRTACRWQSMTSSNEVMGQRYRAAMAKMSVLGFDRNALTDCSDVIPSAVSNNAAPVIPGGLTVDDIEVSCPSEPFPEIATASGPLPSLAPAP

SEQ ID NO: 2 - protein, 513 aa, Marasmius scorodonius
MKLFSASVFAAIIASHYASATAHIRAPNVKPRRTNSLLTAPPQQPPLPSAQQAASASSSAGLNLTDIQGDILIGMKKNKELFFFFSITDAATFKAKLGSDILELITSTNQLLAVATQPITAVNVAFSSTGLKALGITDDLKDPVFEAGMLSNAVSDLSDPGTGNWVPGFVGTSVHGVFLLASDTIDNVNTELANIQTILNGSITEIHRLQGEARPGDQQGHEHFGFMDGISNPAVDGFTPPAEIRPGQALIPPGIMLLGEANDTFQNDRPPWAKDGSFLVFRQMQQRAPEFNKFLQDHALNMPNMTSEQGADLLGARIVGRWKSDAPIDLTPLVDDPVLAADNQRNNNFDFSDATNQTRCPFSAHIRKANPRGDLGGINKFPNQHIIRAGIPYGPEVTDAEKASNSSSTDPSLERGLAFVAYQSNIQNGFVFLQKNWVDNTNFFRPGTGVDPLIGTNSRNSGTDAPNTPRVVSGLDPNNATSTIEIGIDFVVSRGGEYFFSPSLSAIRTVLSV

SEQ ID NO: 3 - protein, 361 aa, Pleurotus eryngii
MSFKTLSALALALGAAVQFASAAVPLVQKRATCADGRTTANAACCVLFPILDDIQENLFDGAQCGEEVHESLRLTFHDAIGFSPTLGGGGADGSIIAFDTIETNFPANAGIDEIVSAQKPFVAKHNISAGDFIQFAGAVGVSNCPGGVRIPFFLGRPDAVAASPDHLVPEPFDSVDSILARMSDAGFSPVEVVWLLASHSIAAADKVDPSIPGTPFDSTPGVFDSQFFIETQLKGRLFPGTADNKGEAQSPLQGEIRLQSDHLLARDPQTACEWQSMVNNQPKIQNRFAATMSKMALLGQDKTKLIDCSDVIPTPPALVGAAHLPAGFSLSDVEQACAATPFPALTADPGPVTSVPPVPGS